(19) United States
(12) Patent Application Publication
(10) Pub. No.: US 2015/0206094 A1
(43) Pub. Date: Jul. 23, 2015

(54) ASSET TRACKING SYSTEM AND METHOD INCORPORATING SWITCHABLE ANTENNA

(71) Applicants: Brenda Hayes, Madison, AL (US); Jack Hayes, Madison, AL (US); Michael F. Lucero, Toney, AL (US); Michael J. Balducci, Arab, AL (US); AVOCENT HUNTSVILLE CORP., Huntsville, AL (US)

(72) Inventors: Jack Hayes, Madison, AL (US); Michael F. Lucero, Toney, AL (US); Michael J. Balducci, Arab, AL (US)

(21) Appl. No.: 14/418,295

(22) PCT Filed: Jul. 30, 2013
(86) PCT No.: PCT/US13/52699

§ 371 Date: Jan. 29, 2015

Related U.S. Application Data
(60) Provisional application No. 61/677,122, filed on Jul. 30, 2012.

(51) Int. Cl. G06Q 10/08; G06K 7/10

(52) U.S. Cl. CPC G06Q 10/087; G06K 7/10366

(57) ABSTRACT

The present disclosure relates to an asset tracking system for tracking assets configured to be rack mounted in at least one of a plurality of shelf (“U”) locations of an equipment rack. The system may have a plurality of radio frequency identification (RFID) tags each secured to a separate asset and encoded with information concerning the asset to which it is secured. A plurality of antennas may each be secured adjacent to specific shelf locations. This uniquely associates each antenna with at least one specific shelf location. A subsystem selectively obtains information from the antennas, one by one, to determine when assets are positioned in specific ones of the shelf locations. The RFID tags may also supply information on an identity of each asset present in each shelf location.

### CROSS-REFERENCE TO RELATED APPLICATIONS

The present application claims priority from U.S. Provisional Application Ser. No. 61/677,122 filed on Jul. 30, 2012. The entire disclosure of the above-referenced application is incorporated herein by reference.

### FIELD

The present disclosure relates to asset tracking systems and methods, and more particularly to an asset tracking system and method for use with equipment racks which incorporates a switchable antenna that can be selectively activated to sense an RF sensing device, carried on an asset, which has been moved into a shelf position of the rack in close proximity to the antenna.

### BACKGROUND

This section provides background information related to the present disclosure which is not necessarily prior art.

Many attempts have been made at developing asset tracking systems to help data center personnel track and monitor the locations of various computer and network related components in a data center. Asset tracking has become extremely important as the size and complexity of modern day data centers has increased. Present day data centers may often include hundreds or even thousands of data center components including servers, network switches, integrated keyboard/display systems, etc.

Many of these modern day data center components are designed to fit in industry standard equipment racks. In large data centers there may be hundreds or even thousands of such racks within one or more distinct rooms that make up the data center. Keeping an inventory of assets in the data center can thus become quite challenging. If manual records are kept, then the burden is on data center personnel to manually note in which specific rack specific equipment rack items are installed. When equipment is moved from one rack to a different rack, the data center worker must manually note this change. Obviously, this method presents significant opportunity for error in recording the locations of data center devices and maintaining up to date equipment location records.

Various automated systems have also been developed which make use of RFID (Radio Frequency Identification) tags that are placed on assets (i.e., components) before the assets are placed in a rack. These systems have met with varying degrees of success. Some have required an RFID at each “U” location (i.e., each equipment slot) of a rack as well as a separate RFID tag on each piece of equipment. The RFID tag on the equipment covers up the RFID tag at a given U location when a piece of equipment is inserted into that specific U location. An antenna determines when the signal being sensed changes. As can be appreciated, this type of system thus requires the use of two RFID tags for each U location where a piece of equipment is installed. In a data center employing hundreds or thousands of rack mounted equipment items, with possibly hundreds or even thousands of racks, this type of sensing system can be prohibitively costly.

### SUMMARY

In one aspect the present disclosure relates to an asset tracking system for tracking assets configured to be rack mounted in at least one of a plurality of shelf (“U”) locations of an equipment rack. The system may comprise a plurality of radio frequency identification (RFID) tags. Each RFID tag may be secured to a separate rack mountable asset and may be encoded with identification information concerning the rack mountable asset to which it is secured. The information may uniquely associate each rack mountable asset with its associated RFID tag. A plurality of antennas may each be secured to the equipment rack adjacent a specific shelf location of the equipment rack. In this manner each antenna is uniquely associated with at least one specific shelf location of the equipment rack. A subsystem may be configured to selectively read information from the antennas, one by one, to determine when rack mountable assets are positioned in specific ones of the shelf locations of the equipment rack. The RFID tags may also supply information on an identity of each rack mountable asset present in each shelf location.

In another aspect the present disclosure relates to an asset tracking system for tracking assets configured to be rack mounted in at least one of a plurality of shelf (“U”) locations of an equipment rack. The system may comprise a plurality of radio frequency identification (RFID) tags. Each one of the RFID tags may be secured to a separate rack mountable component and may be encoded with identification information concerning the rack mountable asset to which it is secured. The information uniquely associates each rack mountable asset with its RFID tag. A plurality of antennas may be secured to the equipment rack adjacent a specific shelf location of the equipment rack. In this manner each antenna is uniquely associated with at least one specific shelf location of the equipment rack. A plurality of switches may each be uniquely associated with one of the antennas. A radio frequency identification (RFID) tag reader may be included for reading information obtained from the RFID tags via the antennas. A processing system may be used for controlling operation of the switches and using information obtained from the RFID tag reader to determine which shelf locations of the equipment rack have assets installed therein, as well as an identity of each asset installed in each shelf location of the equipment rack.

In yet another aspect the present disclosure relates to a method for tracking rack mountable assets configured to be mounted in an equipment rack, and where the equipment rack has a plurality of shelf locations for receiving the rack mountable assets. The method may comprise securing radio frequency identification (RFID) tags to separate rack mountable assets. The method may also involve encoding the RFID tags with identification information concerning the rack mountable asset to which it is secured. This serves to uniquely associate each rack mountable asset with its RFID tag. The method may further involve securing a plurality of antennas adjacent specific shelf locations of the equipment rack such that each antenna is uniquely associated with at least one specific shelf location of the equipment rack. The antennas may be used, one by one, to obtain information from the RFID tags, one by one, to determine when rack mountable assets are positioned in specific ones of the shelf locations of the equipment rack. Information may also be obtained on an identity of each rack mountable asset present in each shelf location of the equipment rack.

### DRAWINGS

The drawings described herein are for illustrative purposes only of selected embodiments and not all possible implementations, and are not intended to limit the scope of the present disclosure.

FIG. 1 is a high level block diagram of one embodiment of a system in accordance with the present disclosure in which a switchable antenna system is used to sense the presence of an RFID tag at each U location of an equipment rack; and

FIG. 2 is a flowchart illustrating various operations that may be performed by the system shown in FIG. 1.

Corresponding reference numerals indicate corresponding parts throughout the several views of the drawings.

### DETAILED DESCRIPTION

Example embodiments will now be described more fully with reference to the accompanying drawings.

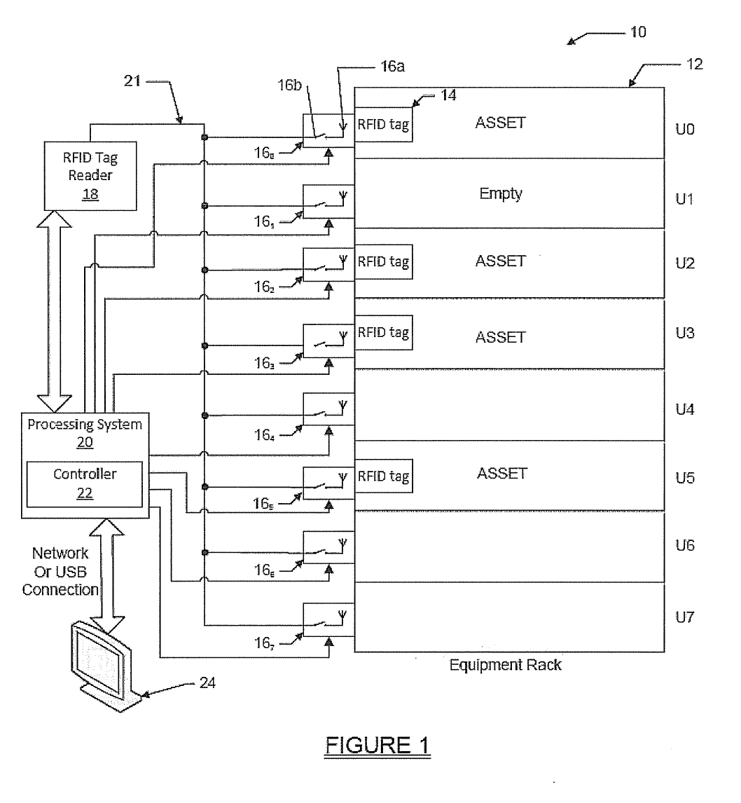

Referring to FIG. 1 there is shown a system 10 in accordance with one embodiment of the present disclosure. The system is well suited to sensing the presence and/or absence of equipment at each U location within an equipment rack 12. In this example the equipment rack has eight U locations labeled U0-U7. Locations U0, U2, U3 and U5 have assets positioned therein. The assets may be servers, network switches, an integrated keyboard/display system, etc. It is also possible that one asset may take up two or more U locations in the rack 12, although for this example the assets are all shown as each taking up a single U location.

Each asset further includes an RFID tag 14 positioned thereon. The RFID tags are each positioned on a common side of the asset, in this example along the left side of each asset and preferably near either a forward edge of the asset or a rear edge of the asset. Preferably, the RFID tags 14 are generally vertically aligned with one another when the assets are fully inserted into the U locations of the rack 12. Each RFID tag 14 may be programmed in advance with various information about the asset to which it will be attached. Various information such as make, model number, type of device, serial number, power requirements, warranty information, etc., may be encoded onto each RFID tag 14.

The system 10 further makes use of a plurality of switchable antenna systems 16₀-16₇, which are positioned on the rack 12 to correspond to U locations 0-7. By that it is meant that they are aligned with their respective U location such that when, for example, an asset is inserted into the U0 location, the switchable antenna system 16₀ will be in close proximity to the RFID tag on the asset and will be able to wirelessly sense or “read” the data encoded onto the RFID tag 14. It will be appreciated that wherever the RFID tags 14 are located on their respective assets, the wireless reception range will be quite limited, preferably on the order of about one meter, and more preferably less than one meter. More preferably still, the RFID tags will be selected and/or configured such that a transmission range of each is on the order of only an inch or two, which eliminates the possibility of one antenna picking up wireless signals from two different RFID tags. It will also be appreciated that, preferably, there will be one antenna system for each U location of a rack. Thus, if a rack with 10 U locations is being used, then there would be ten antenna systems 16 employed. It is possible, however, that if one knows in advance that a rack will be using one or more components that each take up 2 U locations in the rack 12, that a correspondingly lesser number of antenna systems could be employed. But a separate antenna system 16 should be used for each component that will be placed in the rack 12.

Each of the switchable antenna systems 16₀-16₇ may incorporate an antenna element 16a and a switch 16b. The antenna element 16a may take any variety of forms, for example a trace antenna on a printed circuit board (PCB). The switch 16b may also take a variety of forms but in one preferred form may be an RF FET switch. When the switch 16b is open, the antenna element 16a is disabled, meaning it is not able to pass any sensed data from an adjacent RFID tag 14 on to an RFID reader subsystem 18 of the system 10. When the switch 16b is closed, then the antenna element 16a is active and will be providing any wirelessly sensed information from an adjacent RFID tag to other components of the system 10. An RFID reader subsystem 18 is able to decode the signals received from each of the antenna systems 16 and to pass the decoded signals on to a processing system 20. Together the RFID reader subsystem 18 and the processing system 20 form a subsystem for obtaining and using the information collected via the antenna systems 16 from the RFID tags 14.

Referring further to FIG. 1, the system 10 may include a controller 22 responsive to the processing system 20, or as part of the processing system 20, for controlling activation of each of the antenna systems 16₀-16₇ via an associated control line 21. More specifically, the controller 22 may be a microcontroller that selectively opens or closes the switches 16b of each antenna system 16₀-16₇ via its associated control line 21, one at a time, so each antenna system 16₀-16₇ may wirelessly sense and obtain any information from an adjacently positioned RFID tag 14 on an asset. The controller 22 may turn on the antenna systems 16₀-16₇ sequentially while incorporating a suitable delay between the turn on of adjacent antenna systems, or the antenna systems may be activated in any desired order. It is not imperative that the sensing of each U location be accomplished at very short time intervals. Since the system 10 is using newly obtained information and comparing it to previously obtained information for a given U (i.e., shelf location) to detect whether a change in equipment configuration has occurred in the rack 12 (i.e., either the insertion of a new component into a U location or the removal of a component at a given U location), and since these actions will not be happening several times per second, it would be sufficient if each antenna system 16₀-16₇ is turned on possibly only 1 or more times per hour throughout the day. However, virtually any desired frequency of checking the U locations could be employed.

Optionally, a display 24 may also be used by which the processing system 20 can use a suitable software program to display information on the assets present in each and every equipment rack in the data center. The information could be displayed in a list format, or possibly in a graphical format, or even a combination of the two.

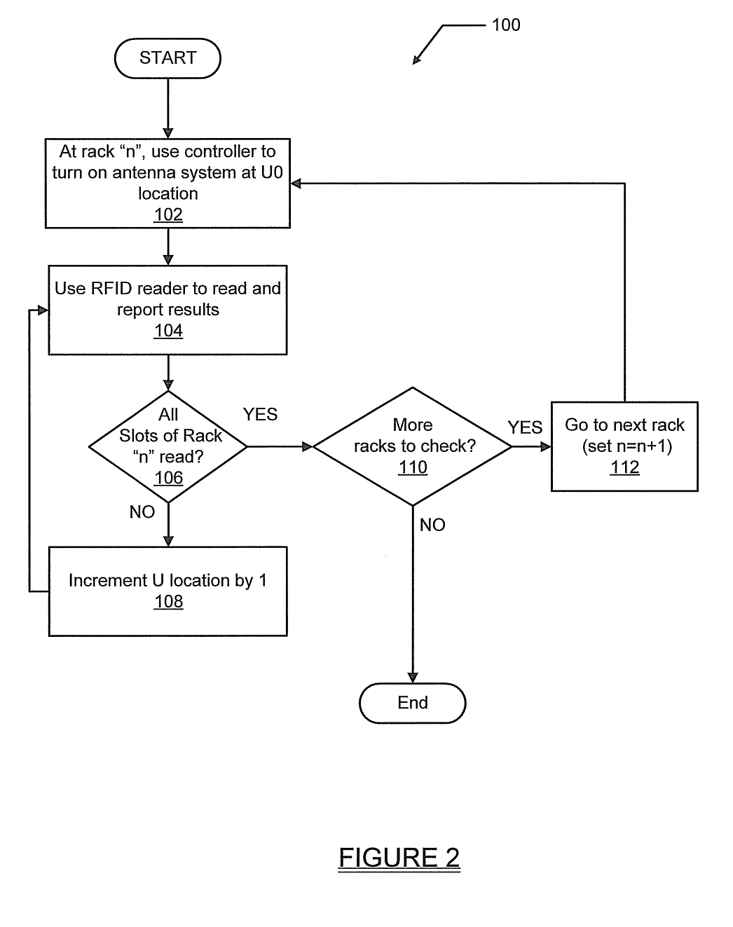

Turning now to FIG. 2, a flowchart 100 illustrating one example of a sequence of operation will be described for the system 10 shown in FIG. 1. Initially at operation 102 the controller 22 is used to initiate a polling cycle by turning on the antenna system 16₀ at rack location U0. At operation 104 the RFID reader 18 is then used to read the information obtained by the antenna element 16a. At operation 106 a check is then made to see if all the U locations of the rack 12 have been checked during the current polling cycle. If the answer to this check is no, then the U location is incremented by 1, as indicated at operation 108, and operations 104 and 106 are repeated.

If the check at operation 106 indicates that all the U locations of the rack 12 have been checked during a single polling cycle, then a check is made at operation 110 to determine if there are more racks 12 to check. If the answer at operation 110 is “no”, then the routine may end, or may be altered to immediately start over checking the first numbered rack. If the check at operation 110 indicates that there are additional racks to check, then at operation 112 the rack number of the next rack to check is incremented by 1, and then operations 102-108 are repeated. It will be appreciated that a suitable software system may be running on the processing system 20 which has information coded into it that indicates the total number of racks in the data center that need to be checked.

The methodology shown in FIG. 2 could also allow the system 10 to go to any specific rack in the data center and make a check of the components within every U location of the chosen rack. Still another feature that could be easily implemented would be a component lookup feature where the user types in a component identifier (serial number, model number, etc.), and the system 10 indicates (either graphically or via a list) the location (or locations) of any and all such components present in the data center. Those skilled in the art will appreciate that various other enhancements could be made to accommodate specific data center needs.

A significant advantage of the system 10 is that only a single RFID tag needs to be used for the U location sensing to be accomplished. This may result in a significant cost savings over asset identification/tracking systems that require the use of two RFID tags for each U location of a rack. Also, no manual action is required by a data center person to collect or track asset information. The system 10 will automatically sense when a component is inserted into a rack, as well as when a component is removed from a rack, and will record this information for data center personnel to use. By “automatically sense” it is meant that the insertion of an asset in the rack or removal of an asset from the rack will be detected by the system 10 during its polling of the antenna elements 16 and its comparisons of newly obtained information with previously obtained information for each U location of the equipment rack.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An asset tracking system for tracking assets configured to be rack mounted in at least one of a plurality of shelf (“U”) locations of an equipment rack, the system comprising:
a plurality of radio frequency identification (RFID) tags, each one of said RFID tags being secured to a separate rack mountable asset and being encoded with identification information concerning the rack mountable asset to which it is secured which uniquely associates each said rack mountable asset with its associated said RFID tag;
a plurality of antennas each being secured to the equipment rack adjacent a specific shelf location of the equipment rack such that each said antenna is uniquely associated with at least one specific shelf location of the equipment rack;
a subsystem configured to selectively read information from the antennas, one by one, to determine when rack mountable assets are positioned in specific ones of the shelf locations of the equipment rack, as well as information on an identity of each said rack mountable asset present in each said shelf location; and
the system further able to perform a component lookup based on a selected criterion of at least one of serial number and model number, to determine locations of each component meeting the selected criterion.

2. The system of claim 1, wherein the subsystem configured to selectively read information from the antennas comprises:
a plurality of switches, each said switch being in communication with, and uniquely associated with, an associated one of the antennas.

3. The system of claim 2, wherein the subsystem configured to selectively read information from the antennas further comprises:
a radio frequency identification (RFID) tag reader for reading information obtained from the RFID tags via the antennas;
a processing system for controlling operation of the switches and using information obtained from said RFID tag reader to determine which said shelf locations of the equipment rack have rack mountable assets installed therein, as well as an identity of each said rack mountable asset installed in each said shelf location of the equipment rack.

4. The system of claim 3, wherein the processing system sequentially controls the switches such that the switches are closed, one by one, to place the RFID tag reader in communication with each of the antennas one at a time.

5. The system of claim 4, wherein the information on the identity of each said rack mountable asset comprises at least one of the following:
a make of the rack mountable asset to which the RFID tag is secured:
a model number of the rack mountable asset to which the RFID tag is secured;
a type of device that the rack mountable asset to which the RFID tag is secured is classified as;
a serial number of the rack mountable asset to which the RFID tag is secured;
a power requirement of the rack mountable asset to which the RFID tag is secured; and
warranty information concerning the rack mountable asset to which the RFID tag is secured.

6. The system of claim 1, wherein each said RFID tag is secured to a side portion of its associated said rack mountable asset.

7. The system of claim 6, wherein each said RFID tag is secured adjacent to one of a front edge or a rear edge of the side portion of its associated said rack mountable asset.

8. An asset tracking system for tracking assets configured to be rack mounted in at least one of a plurality of shelf (“U”) locations of an equipment rack, the system comprising:
a plurality of radio frequency identification (RFID) tags, each one of said RFID tags being secured to a separate rack mountable asset and being encoded with identification information concerning the rack mountable asset to which it is secured which uniquely associates each said rack mountable asset with its associated said RFID tag;
a plurality of antennas each being secured to the equipment rack adjacent a specific shelf location of the equipment rack such that each said antenna is uniquely associated with at least one specific shelf location of the equipment rack;
a plurality of switches each being uniquely associated with one of said antennas;
a radio frequency identification (RFID) tag reader for reading information obtained from the RFID tags via the antennas;
a processing system for controlling operation of said switches and using information obtained from said RFID tag reader to determine which said shelf locations of the equipment rack have assets installed therein, as well as an identity of each said asset installed in each said shelf location of the equipment rack; and
the system further able to perform a component lookup based on a selected criterion of at least one of serial number and model number, to determine locations of each component meeting the selected criterion.

9. The system of claim 8, wherein the processing system is configured to sequentially control each of the switches to sequentially obtain information from each of the antennas.

10. The system of claim 8, further including a user device in communication with the processor for making information generated by the processing system available for use by a user.

11. The system of claim 8, wherein the RFID tags are affixed to side portions of the rack mountable assets.

12. The system of claim 8, wherein each of the RFID tags is attached to the side portion of an associated one of the rack mountable assets near either one of:
a forward edge of the rack mountable asset; or
a rear edge of the rack mountable asset.

13. The system of claim 8, wherein the identification information of each of the RFID tags includes at least one of the following types of information:
make of the rack mountable asset to which the RFID tag is secured:
a model number of the rack mountable asset to which the RFID tag is secured;
a type of device that the rack mountable asset to which the RFID tag is secured is classified as;
a serial number of the rack mountable asset to which the RFID tag is secured;
a power requirement of the rack mountable asset to which the RFID tag is secured; and
warranty information concerning the rack mountable asset to which the RFID tag is secured.

14. A method for tracking rack mountable assets configured to be mounted in an equipment rack, where the equipment rack has a plurality of shelf locations for receiving the rack mountable assets, the method comprising:
securing radio frequency identification (RFID) tags to separate rack mountable assets;
encoding the RFID tags with identification information concerning the rack mountable asset to which it is secured which uniquely associates each said rack mountable asset with its associated said RFID tag;
securing a plurality of antennas each adjacent specific shelf locations of the equipment rack such that each said antenna is uniquely associated with at least one specific shelf location of the equipment rack;
using the antennas, one by one, to obtain information from the RFID tags, one by one, to determine when rack mountable assets are positioned in specific ones of the shelf locations of the equipment rack, as well as information on an identity of each said rack mountable asset present in each said shelf location;
the system further able to perform a component lookup based on a selected criterion of at least one of serial number and model number, to determine locations of each component meeting the selected criterion.

15. The method of claim 14, wherein using the antennas, one by one, comprises using a plurality of switches, with each said switch being in communication with, and uniquely associated with, an associated one of the antennas, to communicate with each of the antennas one by one.

16. The method of claim 15, wherein using antennas one by one comprises using a radio frequency identification (RFID) tag reader to receive the information obtained from the RFID tags via the antennas.

17. The method of claim 16, wherein using the antennas one by one further comprises using a processing system to control operation of the switches to sequentially obtain the information from the RFID tags.

18. The method of claim 17, further comprising using the processing system to correlate locations of the rack mountable assets with specific ones of the shelf locations of the equipment rack.
